(19) United States
(12) Patent Application Publication
(10) Pub. No.: US 2005/0286248 A1
(43) Pub. Date: Dec. 29, 2005

(54) Multi-level shoe-used lamp device

(76) Inventor: Ming-Bi Weng, Taipei Hsien (TW)

Correspondence Address: Ming-Bi Weng, 235 Chung-Ho, Box 8-24, Taipei, TW

(21) Appl. No.: 10/984,655

(22) Filed: Nov. 10, 2004

(30) Foreign Application Priority Data
Jun. 24, 2004 (CN) 2004200665670

(51) Int. Cl. F21V 21/08

(52) U.S. Cl. 362/276; 362/103; 362/800

(57) ABSTRACT

A multi-level shoe-used lamp device comprises a plurality of single color light emitting diodes; at least one diode emitting light with wavelength below 5200 angstrom (Å) by using a power supply having a voltage above 4.5 V; a power source including batteries for supplying power to the single color light emitting diodes; a vibration switch for generating a trigger signal when the vibration switch vibrates; and a substrate having an IC control circuit; the substrate being electrically connected to the single color light emitting diodes through conductive wires; when the circuit receiving a trigger signal, it will generate a driving signal to drive the single color light emitting diodes to flash according to a predetermined sequence. The voltage of the power supply is 4.5 V (volts) which is formed by serially connecting two batteries of 1.5V and 3.0V, respectively or the two batteries of 3.0V and 3.0V, respectively.

### FIELD OF THE INVENTION

The present invention relates to shoes with light emitting diodes, and particular to a multi-level shoe-used lamp device, which are driven by two different voltage levels so as to present different flash effect.

### BACKGROUND OF THE INVENTION

In the prior art U.S. Pat. No. 6,525,487, assigned to the inventor of the present invention, in that the power supply of a shoe is formed by a first battery of 1.5V and a second battery of 3.0V. The first and second batteries are serially connected so as to have a voltage of 4.5V which can afford voltages of 3.0 V and 4.5V to light emitting diodes.

The wavelength of visual light is from 4000 to 7000 angstroms (1 Å=10⁻⁸ cm=10⁻⁴ micrometer). In general, the wavelength of purple light is between 4,000˜4,500 angstrom, the wavelength of blue light is between 4,500˜5,200 angstrom, the wavelength of green light is between 5,200˜5,600 angstroms, the wavelength of yellow light is between 5,600˜6,000, the wavelength of original light is between 6,000˜6,250 angstrom, and the wavelength of red light is between 6,250˜7,000 angstrom. Voltage of 3.0V serves to light up the light emitting diodes of red color, orange color, green color, etc., and voltage above 4.5V serves for lighting up the light emitting diodes of blue color, purple color, pink color, white color, etc. because the lighting emitting diode emitting these colors need high voltages to drive them so as to emit lights with sufficient strengths.

Through experiences of many times, it is discovered that if a voltage above 4.5V, for example, 6.0V is used to drive the light emitting diodes of blue color, purple color, pink color, white color, etc., then these diodes can emit lights with stronger strengths than the result got by using a voltage of 4.5V, and a voltage of 4.5V is supplied to the light emitting diodes of red color, orange color, green color, etc., then the emit lights have strengths and effects preferred than those used in the prior art.

The various objects and advantages of the present invention will be more readily understood from the following detailed description when read in conjunction with the appended drawing.

### SUMMARY OF THE INVENTION

Accordingly, the primary object of the present invention is to provide a multi-level shoe-used lamp device, a voltage of 6.0V is used to drive the light emitting diodes of blue color, purple color, pink color, white color, etc., then these diodes can emit lights with stronger strengths than the result got by using a voltage of 4.5V, and a voltage of 4.5V is supplied to the light emitting diodes of red color, orange color, green color, etc., then the emit lights have strengths and effects preferred than those used in the prior art.

To achieve above objects, the present invention provides a multi-level shoe-used lamp device which comprises a plurality of single color light emitting diodes; at least one diode emitting light with wavelength below 5200 angstrom (Å) by using a power supply having a voltage above 4.5 V; a power source including batteries for supplying power to the single color light emitting diodes; a vibration switch for generating a trigger signal when the vibration switch vibrates; and a substrate having an IC control circuit; the substrate being electrically connected to the single color light emitting diodes through conductive wires; when the circuit receiving a trigger signal, it will generate a driving signal to drive the single color light emitting diodes to flash according to a predetermined sequence. The voltage of the power supply is 4.5 V (volts) which is formed by serially connecting two batteries of 1.5V and 3.0V, respectively or the two batteries of 3.0V and 3.0V, respectively.

### BRIEF DESCRIPTION OF THE DRAWINGS

FIG. 1 is a schematic perspective view of the first embodiment of the present invention.

FIG. 2 is a schematic perspective view of the second embodiment of the present invention.

FIG. 3 is a schematic perspective view of the third embodiment of the present invention.

FIG. 4 shows the circuit in the first embodiment of the present invention.

FIG. 5 is a circuit of the second embodiment of the present invention.

FIG. 6 shows the third circuit of the present invention.

FIG. 7 shows the circuit block diagram of the present invention.

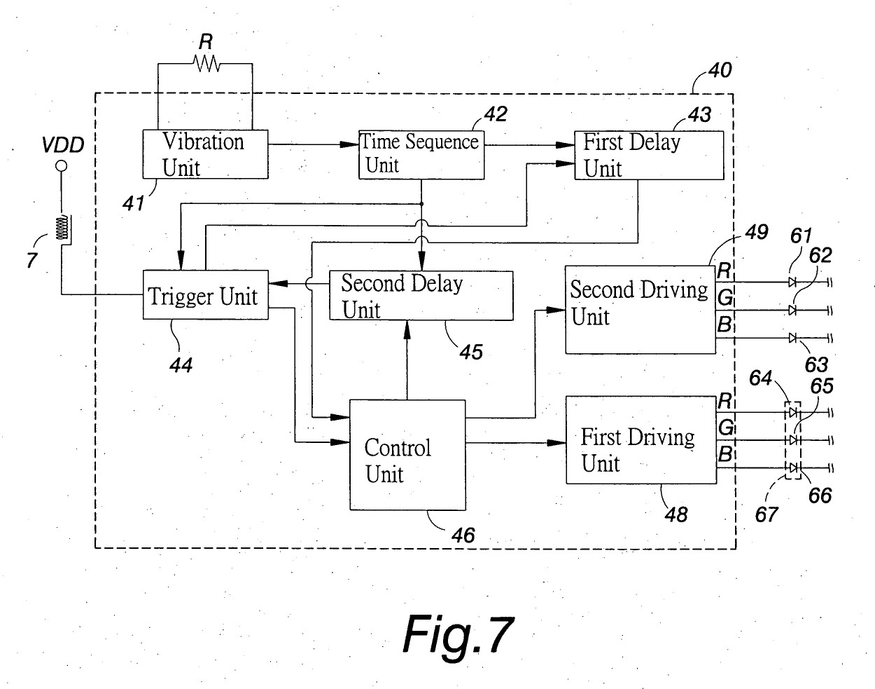

FIG. 8 is a schematic view showing that the present invention is installed within a shoe.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

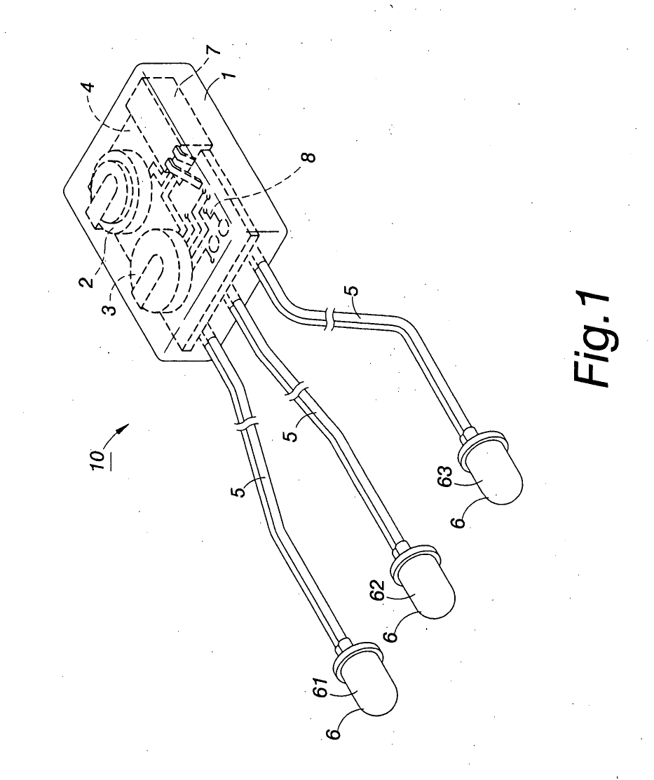

With reference to FIG. 1, the multi-level shoe-used lamp device 10 of the present invention is illustrated. The multi-level shoe-used lamp device 10 includes the following elements.

A plurality of single color light emitting diodes 6 are includes. At least one single color light emitting diode 6 emits light with wavelength below 5200 angstrom (Å) with a voltage above 4.5 V;

A power source including batteries 2, 3 serves for supplying power to the single color light emitting diodes 6;

A vibration switch 7 serves for generating a trigger signal when the vibration switch 7 vibrates; and

A substrate 4 has an IC control circuit and is electrically connected to the single color light emitting diodes 6 through the conductive wires 5. When the circuit receives a trigger signal, it will generate a driving signal to drive the single color light emitting diodes 6 to flash according to a predetermined sequence.

The single color light emitting diodes 6 have various colors and are installed independent. In the drawing, the single color light emitting diode 61 is a red color light emitting diode. The single color light emitting diode 62 is a green color light emitting diode and the single color light emitting diode 63 is a blue color light emitting diode. Each single color light emitting diode 6 is connected to the substrate 4 through a negative and a positive conductive wires 5. The blue color light emitting diode 63 has wavelengths below 5200 angstrom by a power supply about 4.5 V.

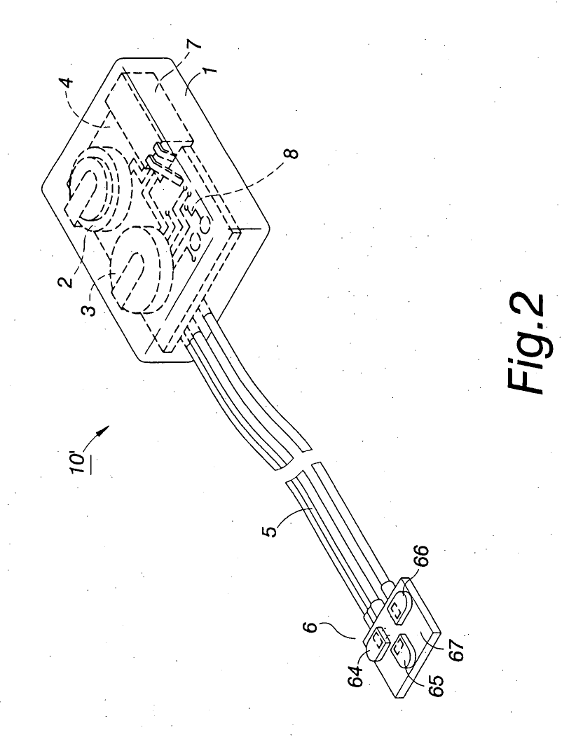

With reference to FIG. 2, the multi-level shoe-used lamp device 10′ of the second embodiment of the present invention is illustrated. The difference of this embodiment from the previous one is that a plurality of single color light emitting diodes 6 with various colors are installed on one substrate 67. For example, a red color light emitting diode 64, a green color light emitting diode 65, and a blue color light emitting diode 66 are installed. The wavelength of the blue color light emitting diode is below 5200 angstrom by a power supply of 4.5 V. The three single color light emitting diodes 6 can present various colors by mixing the emitting lights. The conductive wires 5 may be a wire bus.

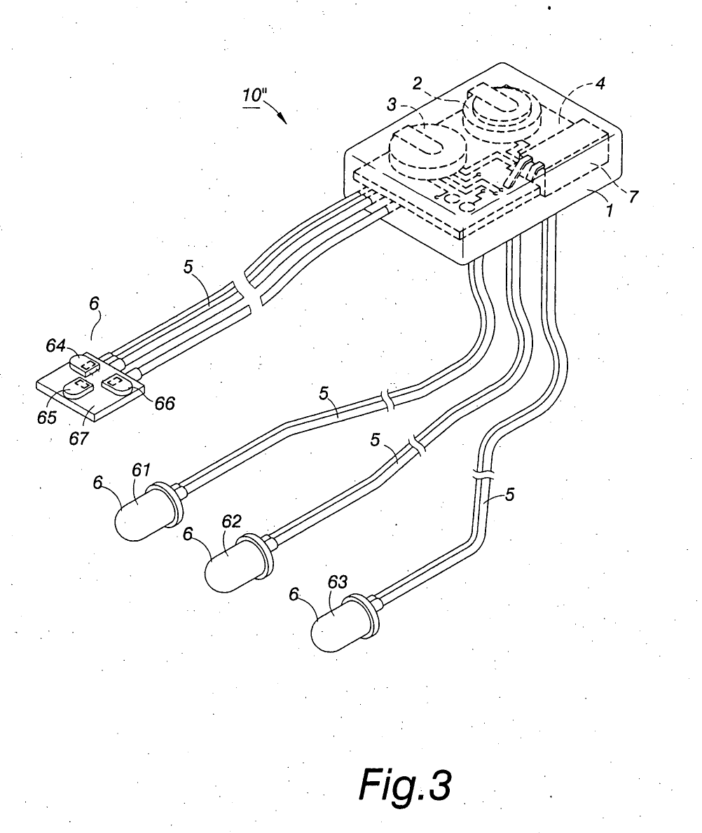

With reference to FIG. 3, the third embodiment of the multi-level shoe-used lamp device 10″ according to the present invention is illustrated. In the present invention, there are two sets of single color light emitting diodes 6. One has the single color light emitting diodes 61 to 63 as those in the first embodiment and the other has the single color light emitting diodes 6 as those in the second embodiment. The conductive wires 5 connecting the single color light emitting diodes 61 to 63 are individual wires 5 and the conductive wires 5 connecting the single color light emitting diode 64 to 66 form a wire bus.

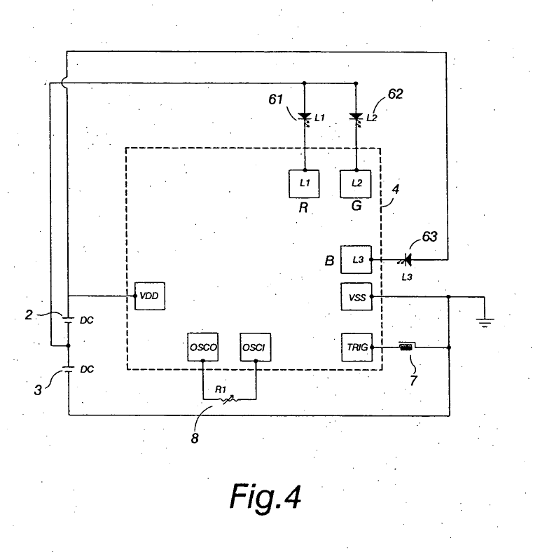

With reference to FIG. 4, in the multi-level shoe-used lamp device 10 of the first embodiment, the pins L1 to L3 are retained to the output pins of the single color light emitting diodes 61 to 63. The pin VDD is a positive electrode with a DC of 3.0 Volt. The pin VSS is a negative electrode. The pin TRIG serves for triggering the vibration switch 7. The power source is formed by a first battery 2 of 3.0V and a second battery 3 of 1.5V so as to provide voltage levels of 3.0V and 4.5V to the substrate 4 and the single color light emitting diodes 61 to 63. The first voltage 2 is connected to the anodes of the red color light emitting diode 61 and the green color light emitting diode 62. The second battery 3 is connected to the anode of the blue color light emitting diode 63. Since the first battery 2 and the second battery 3 are serially connected to have a voltage of 4.5V. Thereby, a voltage level of 3.0V is provided to the red color light emitting diode 61 and the green color light emitting diode 62 and a voltage level of 4.5V is provided to the blue color light emitting diode 63.

Similarly, when a first battery of 3.0 V and a second battery of 3.0 V are serially connected. Then voltages of 3.0 V and 6.0V are provided. That is, the first voltage 2 is connected to the anodes of the red color light emitting diode 61 and the green color light emitting diode 62. The second battery 3 is connected to the anode of the blue color light emitting diode 63. Since the first battery 2 and the second battery 3 are serially connected to have a voltage of 6.0V. Thereby, a voltage level of 3.0V is provided to the red color light emitting diode 61 and the green color light emitting diode 62 and a voltage level of 6.0V is provided to the blue color light emitting diode 63.

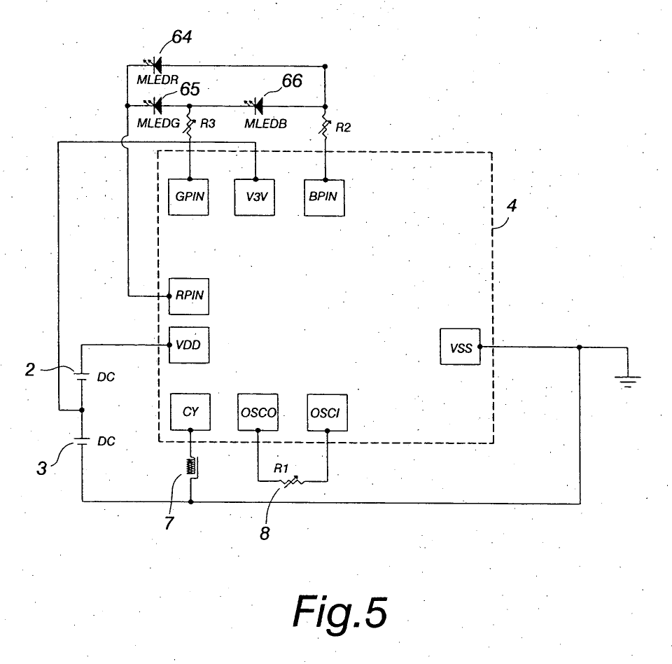

In the second embodiment, see FIG. 5, the pins BPIN, GPIN, and RPIN are connected to the single color light emitting diodes 63 and 66. The pin V3V is a positive electrode of a DC of 3.0 volt. The pin VDD is a positive electrode of 4.5 volt (or 6.0 volt). The pin VSS is a negative electrode of the power source. The pin CY serves for the vibration switch 7. Besides, the single color light emitting diodes 64-66 provide various colors by the visual effect (about 1/16 second to 1/24 second).

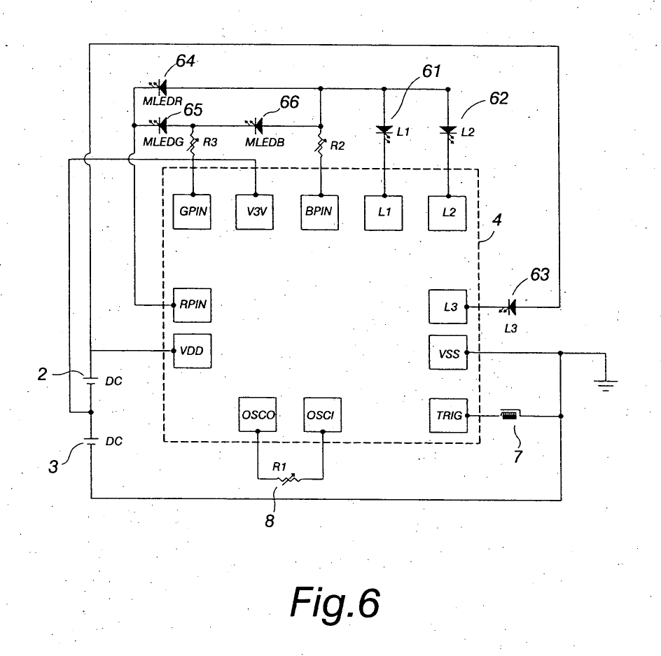

With reference to FIG. 6, in the third embodiment, the pins L1 to L3 are used for the output pins of single color light emitting diodes 61 to 63, the pins BPIN, GPIN, and RPIN are connected to the single color light emitting diodes 63 and 66. The pin V3V is positive electrode of a DC of 3.0 volt. The pin VDD is a positive electrode of 4.5 volt (or 6.0 volt). The pin VSS is a negative electrode of the power source. The pin TRIG serves for the single shot triggering or level triggering the vibration switch 7. The pin CY serves for triggering the switch S1. The pins OSC1 and OSC0 are connected to a vibrating resistor 8. By adjusting the vibrating resistor 8, the pulse is changed.

The IC control circuit 40 used in the third embodiment is illustrated in FIG. 3. The circuit is formed by a vibrating unit 41, a time sequence unit 42, a first delay unit 43, a trigger unit 44, a second delay unit 44, a second delay unit 45, a control unit 46 and a first driving unit 48 for mixing colors; and a second driving unit 49 for driving the single color light emitting diodes. The vibration unit 41 and the time sequence unit 42 serve to generate work frequencies to the first delay unit 43, the trigger unit 44 and the second delay unit 45. The trigger unit 44 is connected to the vibrating switch 7. When the vibration switch 7 vibrates, a first trigger signal is generated to the first delay unit 45 and the control unit 46. The first delay unit 43 serves to cause the IC control circuit 40 to delay the driving signals to the single color light emitting diode 61, 62, 63 and the single color light emitting diodes 64 to 66. In the flash time period, if no new triggering signal is generated, the control unit 46 is disabled.

When the substrate 4 vibrates, the trigger unit 44 generates a trigger signal to the control unit 46. The control unit 46 sends driving signals to the single color light emitting diodes 61 to 63 and the single color light emitting diodes 64 to 66 after a delay time which is determined by the second delay unit 43. At this time, these single color light emitting diodes 61 to 66 flash according to the flash time sequence determined by the second delay unit 45.

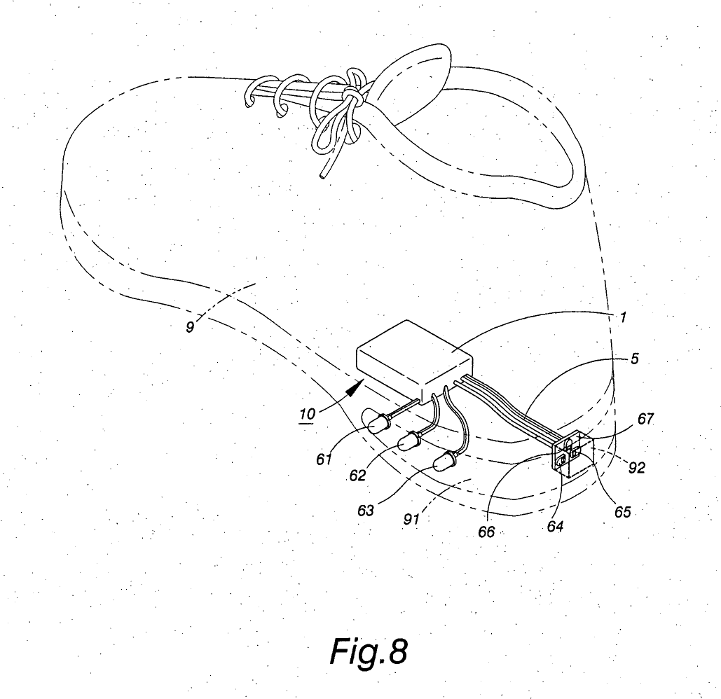

With reference to FIG. 8, it is illustrated that the present invention is installed within a shoe body 9. The light emitting diodes are installed at the periphery of the shoe. The single color light emitting diodes 61 to 63 can flash along various sequences or the single color light emitting diodes 64 to 66 can present various colors by mixing of the lights of different colors.

The power supply, vibration switch and IC circuit are assembled in a casing and the single color light emitting diodes are installed at a shoe which can be seen from outer side of the shoe.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multi-level shoe-used lamp device comprising:
a plurality of single color light emitting diodes; at least one single color light emitting diode emitting light with wavelength below 5200 angstrom (Å) by using a power supply having a voltage above 4.5 V;
a power source including batteries for supplying power to the single color light emitting diodes;
a vibration switch for generating a trigger signal when the vibration switch vibrates; and
a substrate having an IC control circuit; the substrate being electrically connected to the single color light emitting diodes through conductive wires; when the circuit receiving a trigger signal, it will generate a driving signal to drive the single color light emitting diodes to flash according to a predetermined sequence;
wherein the at least one single color light emitting diode emitting light with wavelength below 5200 angstrom (Å) by using a power supply having a voltage above 4.5 V emits light selected from one of blue light and white light.

2. The multi-level shoe-used lamp device as claimed in claim 1, wherein a voltage of the power supply is 4.5 V (volts) which is formed by serially connecting two batteries of 1.5V and 3.0V, respectively.

3. The multi-level shoe-used lamp device as claimed in claim 1, wherein a voltage of the power supply is 6.0 V (volts) which is formed by serially connecting two batteries of 3.0V and 3.0V, respectively.

4. The multi-level shoe-used lamp device as claimed in claim 1, wherein the single color light emitting diodes flash along the positions of the single color light emitting diodes.

5. The multi-level shoe-used lamp device as claimed in claim 1, wherein the flashed sequences are repeated.

6. The multi-level shoe-used lamp device as claimed in claim 1, wherein the power supply, vibration switch and IC circuit are assembled in a casing and the single color light emitting diodes are installed at a shoe which can be seen from outer side of the shoe.

7. The multi-level shoe-used lamp device as claimed in claim 1, wherein a plurality of single color light emitting diodes are installed on a substrate.

8. The multi-level shoe-used lamp device as claimed in claim 1, wherein the plurality of single color light emitting diodes are installed on different substrates.
